(19) United States
(12) Patent Application Publication
(10) Pub. No.: US 2017/0148065 A1
(43) Pub. Date: May 25, 2017

(54) EFFICIENT INTERNET ADVERTISEMENT POSTING

(71) Applicant: Buzz Frenzy LLC, Duluth, MN (US)

(72) Inventor: Daniel Frank Stocke, Duluth, MN (US)

(21) Appl. No.: 14/947,576

(22) Filed: Nov. 20, 2015

(51) Int. Cl. G06Q 30/02; G06F 17/30

(52) U.S. Cl. CPC G06Q 30/0269; G06F 17/30867; G06F 17/30554

(57) ABSTRACT

A computer-implemented method includes retrieving a media posting and searching the media posting for a keyword. When the keyword is present in the media posting, an action associated with the keyword is retrieved and target psychographic information associated with the media posting is retrieved. The action is then executed while utilizing the target psychographic information.

### BACKGROUND

Internet-based advertising platforms, such as Facebook®, Google®, Twitter® and LinkedIn®, provide user interfaces for submitting advertisements to the platform. The user interfaces include controls to enter the creative content of the advertisement such as video, audio, and text. The user interfaces also include controls to set target psychographics for each advertisement, where the target psychographics define the characteristics of users who should be shown the advertisement. Some platforms also provide controls for defining the geographic areas of the users who should receive the advertisements. Some platforms also provide user interfaces with controls for setting an advertising budget and a spend rate for the advertisements.

### SUMMARY

A computer-implemented method includes retrieving a media posting and searching the media posting for a keyword. When the keyword is present in the media posting, an action associated with the keyword is retrieved and target psychographic information associated with the media posting is retrieved. The action is then executed while utilizing the target psychographic information.

In a further embodiment, a server includes a database and a processor. The database associates a posting site on a network with a retail industry and a geographic area. The processor executes a posting searcher that searches the posting site for a keyword and an action executor that executes an action when the posting searcher finds the keyword, wherein the action is applied to the geographic area.

In a still further embodiment, a method is provided that includes searching a posting on a network site for a trigger and when the trigger is found: retrieving psychographic information associated with the posting; and creating and activating an advertisement based on content in the posting and so that the advertisement is directed to people who match the psychographic information.

### BRIEF DESCRIPTION OF THE DRAWINGS

FIG. 1 is a block diagram of a system for promoting postings to advertisements in accordance with one embodiment.

FIG. 2 is flow diagram of a method of establishing an account.

FIG. 3 is an example of a user interface used to establish an account

FIG. 4 is an example of a user interface used to submit advertising funding.

FIG. 5 is a flow diagram of a method of promoting postings to advertisements.

FIG. 6 is a user interface showing postings on a social media page.

FIG. 7 is a user interface showing a posting promoted as an advertisement.

FIG. 8 is a user interface showing engagement results for promoted advertisements.

FIG. 9 shows a block diagram of an exemplary computing device.

### DETAILED DESCRIPTION OF ILLUSTRATIVE EMBODIMENTS

The user interfaces for submitting an advertisement to an internet-based advertising platform are computationally inefficient and require a large amount of computing resources. In particular, multiple user interfaces have to be generated and sent to each user who wishes to submit an advertisement. Further, the resulting advertisements often make inefficient use of the computer network because the target psychographics are improperly set by the users. In particular, the target psychographics often target the wrong audience resulting in advertisements being sent over the network that are of no interest to the users who receive them. These irrelevant advertisements greatly slow the loading time of pages and thus severely impact the performance of the Internet.

The embodiments below provide an efficient system that improves the operation of servers operating on the Internet by reducing the number of user interfaces that are provided to users to convert social media postings into advertisements. Further, the embodiments below improve the target psychographics of advertisements thereby reducing the number of advertisements that are irrelevant to the people who receive them.

Under the various embodiments, target psychographics are generated for each of a collection of products and services by experts in marketing. Thus, for a given product or service, the expert will determine the characteristics of people who are most likely to find the advertisement of interest. Businesses who sell one of the products or services can create an account and associate one or more social media pages they control with the account. When the business wishes to convert a posting on their social media page into an advertisement, the business simply includes a keyword or trigger within the posting. The embodiments below periodically scan the postings for such keywords and promote the postings containing the keywords into advertisements that are directed to the target psychographics set by the expert. The advertisements are also limited to particular geographic areas associated with the account. Thus, the embodiments below make it easy for businesses to promote postings into advertisements that are directed to the proper target psychographics and do not require a large number of user interfaces to be sent through the Internet in order for a business to promote a posting to an advertisement.

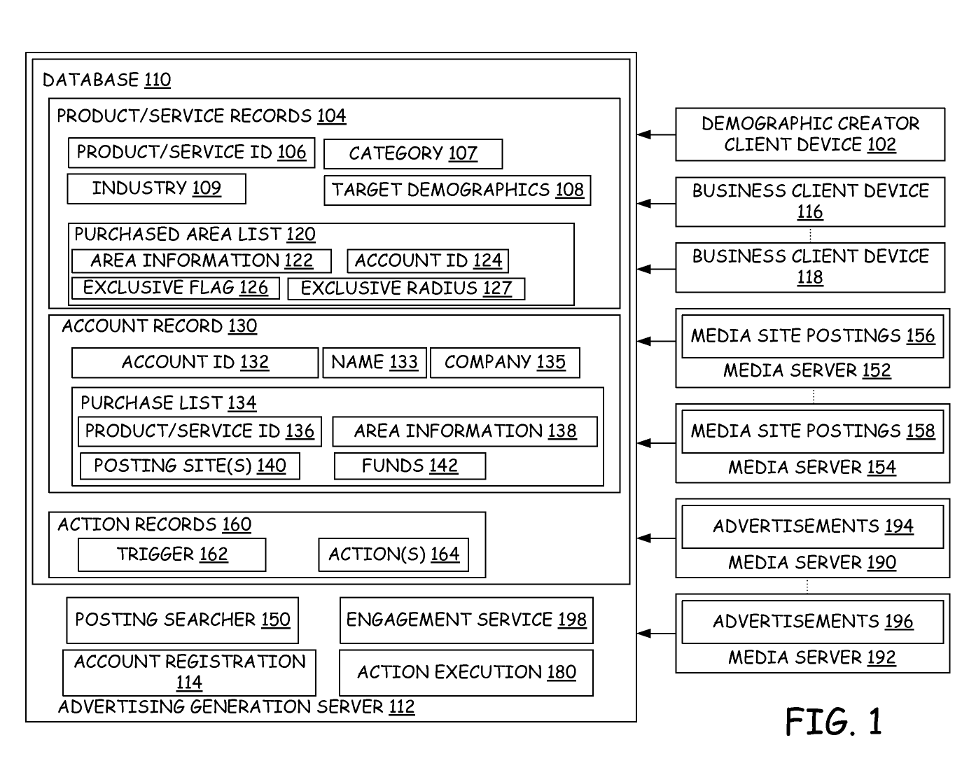

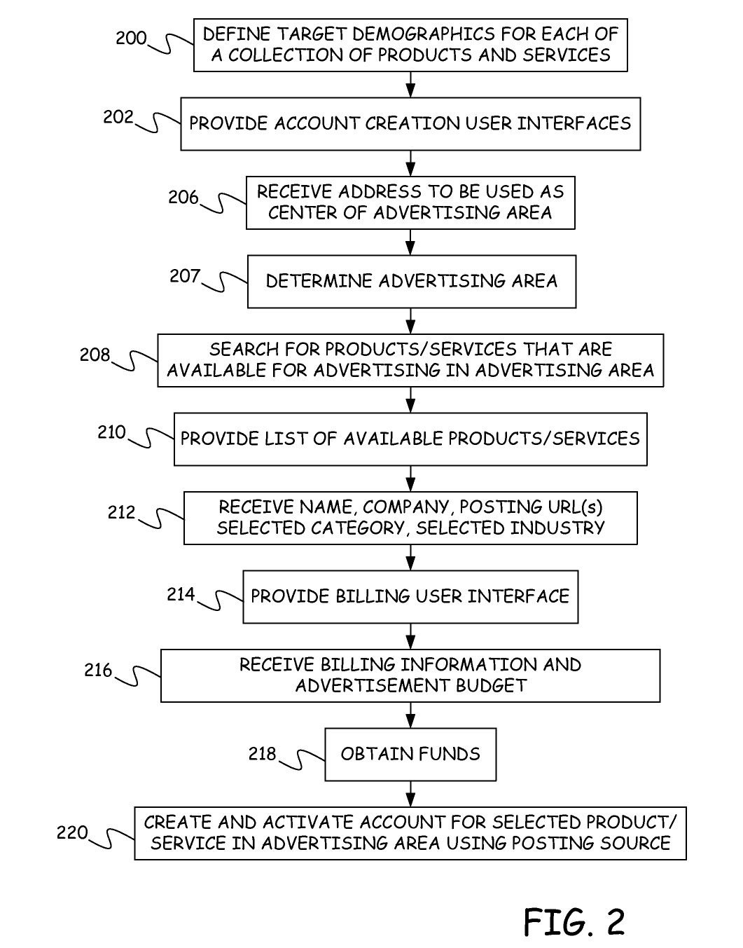

FIG. 1 provides a block diagram of a system used to convert postings into advertisements that are directed to expertly-identified target psychographics. FIG. 2 provides a flow diagram of initializing the system of FIG. 1 and activating an account for a business. In step 200 of FIG. 2, a psychographic creator client device 102 of FIG. 1 is used by a marketing expert to generate target psychographics for each of a collection of products or services. During step 200, a separate product/service record 104 is formed for each product and service. The product/service records 104 are stored in a database 110 of an advertising generation server 112. Each product/service record 104 includes a product/service ID 106 that uniquely identifies the product or service, a category 107 for the product or service, an industry 109 that describes the product or service and the target psychographics 108, also referred to as target psychographic information, generated by the expert using psychographic creator client device 102. Target psychographics can include characteristics of users, such as gender, age, income, occupation, marital status, book interests, movie interests, hobbies and so forth. The target psychographics are set by the expert based on the expert's knowledge of what characteristics are relevant to the particular product or service.

At step 202, an account registration service 114 on advertising generation server 112 provides user interfaces to a business client device, such as business client devices 116 and 118, which receive information that is used to establish an account on advertising generation 112.

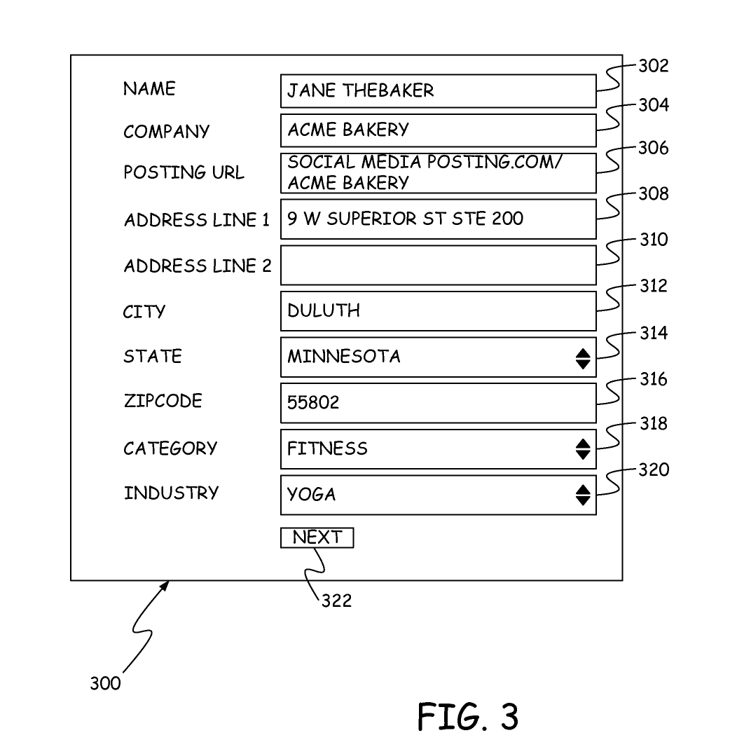

FIG. 3 provides a user interface 300 that is an example of an account creation user interface provided in step 202. User interface 300 includes input textboxes 302 and 304 that receive a name of a user and a name of a company, respectively. Input textbox 306 receives a URL of social media site that will be the posting source for advertisement content. Text input boxes 308, 310, 312, 314 and 316 receive an address to be used as the center of an advertising area where advertising will be focused. Pull-down controls 318 and 320 provide lists of product/service categories and individual products/services in each category, respectively.

In accordance with one embodiment, pull-down control 318 is dynamically populated based on the address in textboxes 308, 310, 312, 314 and 316. Specifically, when pull-down control 318 is selected, the address information in textboxes 308, 310, 312, 314 and 316 is sent to and received by account registration service 114 at step 206. At step 207, the address information is used to define an advertising area. In accordance with one embodiment, the advertising area is defined as an area within a fixed distance of the address received at step 206. For example, the area can span all locations within ten miles of the address.

At step 208, account registration service 114 searches product/service records 104 for products and services that are available for advertising in the advertising area determined in step 207. Specifically, account registration service 114 searches product/service records 104 to determine if any of the products or services have been assigned exclusively to another account for any area that intersects the advertising area. To do this, account registration service 114 examines a purchased area list 120 for each product/service record 104 where each entry in the purchased area list includes a center of advertising area 122, an account ID 124, an exclusive field 126, and an exclusive radius 127. Center of advertising area 122 indicates the center of an advertising area previously purchased for the product or service by a business identified by account ID 124. Exclusive field 126 indicates whether the business identified by account ID 124 is the only business that is allowed to advertise for this product or service in an area that is within the exclusive radius 127 of center 122. If exclusive field 126 indicates that the business identified by account ID 124 is not the only business allowed to advertise within the area defined by exclusive radius 127 and center 122, the product/service identified by product/service record 104 is available for any advertising area that intersects that area. However, if exclusive field 126 indicates that only the business owner associated with account ID 124 may advertise in locations within exclusive radius 127 of center 122, the product or service associated with product/service record 104 is not available to other accounts that have an advertising area that intersects with that area. In step 208, account registration service 114 only returns those products or services that are available for advertising in the advertising area identified in step 207.

At step 210, account registration service 114 provides the category 107 and industry 109 of each available product and service. The list of categories is used to dynamically populate category pulldown 318 and the list of industries is used to dynamically populate industry pulldown 320 of FIG. 3. In accordance with some embodiments, when the user selects one of the categories from category pulldown 318, the list of available industries in industry pulldown 320 is reduced to only the available industries in the selected category.

At step 212, the user of business client device 116/118 selects next button 322, which causes all of the information from user interface 300 to be submitted to and received by account registration service 114. In particular, account registration service 114 receives the name, the company name, URL of the posting site, the address for the center of the advertising area, and the selected category and industry, which together represent the selected product or service.

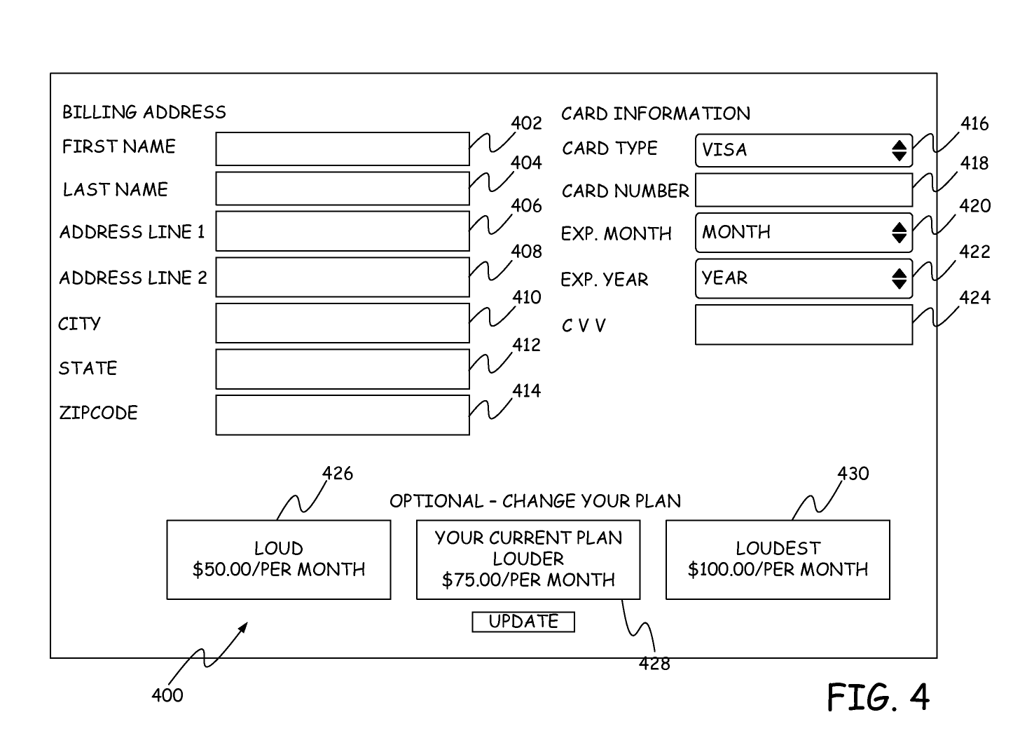

At step 214, a billing-information user interface, such as billing-information user interface 400 of FIG. 4, is provided to business client device 116/118. Billing-information user interface 400 includes first name textbox 402, last name textbox 404, address line textboxes 406 and 408, city textbox 410, state textbox 412 and zipcode textbox 414. Billing-information user interface 400 also includes credit card inputs, such as card type control 416, card number textbox 418, expiration month control 420, expiration year control 422 and security code textbox 424. Billing-information user interface 400 may also provide three controls 426, 428 and 430 that allow the business to set their advertisement spending for the month and thus control the amount of advertising that is published per month. In particular, selecting control 426 sets the advertising budget at $50.00 per month, selecting control 428 sets the advertising budget at $75.00 per month and selecting control 430 sets the advertising budget at $100.00 per month.

At step 216, the billing information and advertising budget from user interface 400 is received by account registration service 114 and the credit card information and billing address information is used to obtain funds from the credit card company at step 218.

At step 220, an account is created for the business using the information received through user interfaces 300 and 400. In particular, an account record 130 is formed that includes an account ID 132, name 133, company 135 and purchase list 134. Account ID 132 is a unique identifier for the account, name 133 is the name provided in textbox 302 of FIG. 3, company 135 is the company name provided in textbox 304, and purchase list 134 includes a list of the products/services and areas that the business wants their advertising directed toward. In particular, each entry in purchase list 134 includes a product/service ID 136 that uniquely identifies the product or service selected using controls 318 and 320 of FIG. 3. In addition, each entry in purchase list 134 includes a center of advertising area 138, also referred to as area information 138, that corresponds with the address entered in address textboxes 308, 310, 312, 314 and 316 of FIG. 3 and identifies the center of the area where advertisements are to be published. Each entry in purchase list 134 also includes posting site(s) 140, which is taken from posting URL textbox 306 of FIG. 3 and indicates the network location of a site that will contain postings that are to be promoted to advertisements by advertising generation server 112. Although a single posting site is shown as being entered in user interface 300, in other embodiments, multiple posting sites may be listed in user interface 300 and may be stored as posting sites 140. Each entry in purchase list 134 also includes a funds field 142, which is initially set to the funds selected using controls 426, 428 and 430 of user interface 400.

In addition to creating account record 130, step 220 involves creating a new entry in purchased area list 120 for the product/service record 104 corresponding to the product/service selected using controls 318 and 320. In particular, a new entry is added to purchased area list 120 of the product/service record 104 that has a product/service ID 106 that matches product/service ID 136 of new account record 130. The new entry includes a center of advertising area 122 corresponding to center 138 of account record 130, account ID 124 corresponding to account ID 132, an indication of whether the area around the center of advertising is exclusive using exclusive flag 126, and the radius of the exclusive area. In accordance with some embodiments, the exclusivity of the area may be purchased for an additional price or may be granted automatically with the purchase of the account. In addition, different radii of exclusion may have different prices. For example, a larger radius of exclusion may cost more than a smaller radius of exclusion.

Thus, after an account has been created, database 110 associates an account with a posting site 140 on a network, a retail industry 109, a geographic area 138/122, and target psychographics 108.

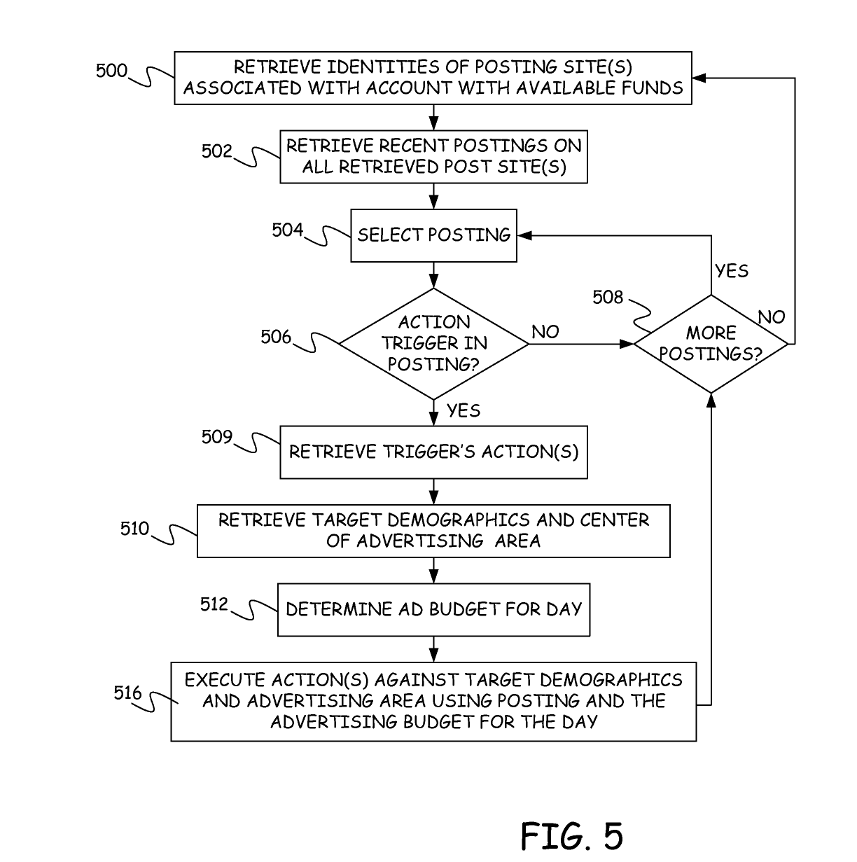

After a business has created an account, the account is integrated into a method for advertising based on postings as shown in the flow diagram of FIG. 5. At step 500 of FIG. 5, a posting searcher 150 of advertising generation server 112 searches account records 130 for an account with available advertising funds and retrieves the associated posting site(s) 140 for that account. At step 502, posting searcher 150 requests media site postings, such as media site posting 156 or media site posting 158, from a respective media server, such as media servers 152 and 154, based on the URL(s) in posting site(s) 140. In accordance with one embodiment, retrieving postings involves retrieving all postings that have been made to the URL since the last time postings were retrieved. Thus, multiple postings can be retrieved during step 502. If multiple posting sites are listed in posting site(s) 140, postings from each of the posting sites are retrieved at step 502.

At step 504, posting searcher 150 selects one of the retrieved postings and at step 506, posting searcher 150 parses the selected posting to determine whether the posting includes an action trigger. Examples of an action trigger include a keyword or phrase, such as “#BUZZFRENZY”. In accordance with one embodiment, database 110 includes a set of action records 160 that include a separate record for each action trigger 162. Each record includes the action trigger 162 and an associated action(s) 164. If no triggers are present in the selected posting at step 506, the process of FIG. 5 continues at step 508 where it determines if any of the retrieved postings still need to be parsed. If another posting needs to be parsed, a new posting is selected by returning to step 504 and step 506 is repeated to parse the selected posting to determine if it contains an action trigger.

If an action trigger is present in a posting, posting searcher 150 retrieves the trigger's associated action 164 at step 509. Different triggers can have different associated advertising actions. For example, different triggers can be associated with a different frequency of advertising such that one trigger is associated with advertising at a steady frequency over the course of a day while another trigger is associated with advertising more frequently in the first hour of advertising than over the remainder of the day. In addition, different triggers can be associated with different advertising budget spends as discussed further below. In a further embodiment, different triggers can be associated with different radii for the advertising area such that one trigger will produce advertisements across a first area and a second trigger will produce advertisements across a second, larger area.

At step 510, posting searcher 150 retrieves the target psychographic information 108 and area information 138 associated with the posting that contained the trigger. To retrieve area information 138, posting searcher 150 retrieves center 138 of the purchased list entry 134 associated with the selected posting. To retrieve the target psychographics, posting searcher 150 retrieves product/service ID 136 of the purchased list entry 134 associated with the selected posting and uses the product/service ID 136 to retrieve the target psychographics 108 for the product/service record 104 associated with the matching product/service ID 106.

For actions that require available funds, posting searcher 150 determines an available budget for advertising the posting using remaining funds 142 associated with posting site 140 at step 512. Remaining funds 142 indicate the amount of funds that are yet to be spent. In accordance with one embodiment, to determine the available budget for advertising the posting, also referred to as an advertisement spending amount, remaining funds 142 is divided by the remaining number of days in the month. In other embodiments, the trigger action 164 associated with the trigger found in the posting determines the advertising budget for the posting. For example, one trigger may cause one budget to be assigned to the posting while another trigger may cause twice that budget to be assigned to the posting.

At step 516, an action execution service 180 is executed to perform action(s) 136 for the posting. One example of an action is to create and activate an advertisement on one or more media servers 190 and 192 such that the media servers will then deliver or direct the advertisement toward people who correspond with or match the target psychographics and who are in a particular advertising area. Creating and activating an advertisement on one or more media servers are alternatively referred to as placing an advertisement with a network site that displays the advertisement to people who correspond with the target psychographic information and who correspond with the area information.

To create and activate (place) the advertisements, action execution service 180 uses advertisement APIs provided by media servers 190 and 192 to set the target psychographics for the advertisement based on target psychographics 108; set the target area for the advertisement based on advertising area center 122/138 and an advertising radius, which can be set by action execution service 180 based on a default value set for the trigger action or which can be set based on a default value provided by media servers 190 and 192. Note that the advertising radius can be the same as or larger than the exclusive radius 127. In embodiments where the advertising radius is larger than the exclusive radius, portions of the target areas of two different businesses can overlap while other portions remain exclusive to each business. For example, the advertising radius can be ten miles while exclusive radius 127 is five miles. Action execution service 180 also uses the advertisement API's to set the content the advertisements. In accordance with one embodiment, action execution service 180 sets entire content of the posting selected at step 504, such as text, hyperlinks, images, video, and/or audio uploaded with the posting, as the creative content of the advertisement. In other embodiments, action execution server 180 sets the content of the advertisement by removing the action trigger from the posting selected at step 504 and setting the remaining content of the posting, such as text, hyperlinks, images, video, and/or audio uploaded with the posting, as the creative content for the advertisement. Action execution service 180 also sets the advertisement budget to match the advertisement budget set at step 512.

Once the advertisement is created and uploaded to media server 190/192 using the media server APIs, media server 190/192 will publish the advertisement on other user's social media pages as a sponsored advertisement. In particular, media server 190/192 will publish the advertisement to other users who meet the target psychographic characteristics and are within the advertising area until the advertisement budget for the day has been spent. In other words, the advertisement placed with the network site is distributed to people in the geographic area that match the psychographic information.

After action execution service 180 has created and submitted the advertisement to the media server(s) 190/192, the process returns to step 508 where posting searcher 150 determines if there are more postings to parse. When there are no more postings to parse for the current account, the process returns to step 500 to search for another account with available funds.

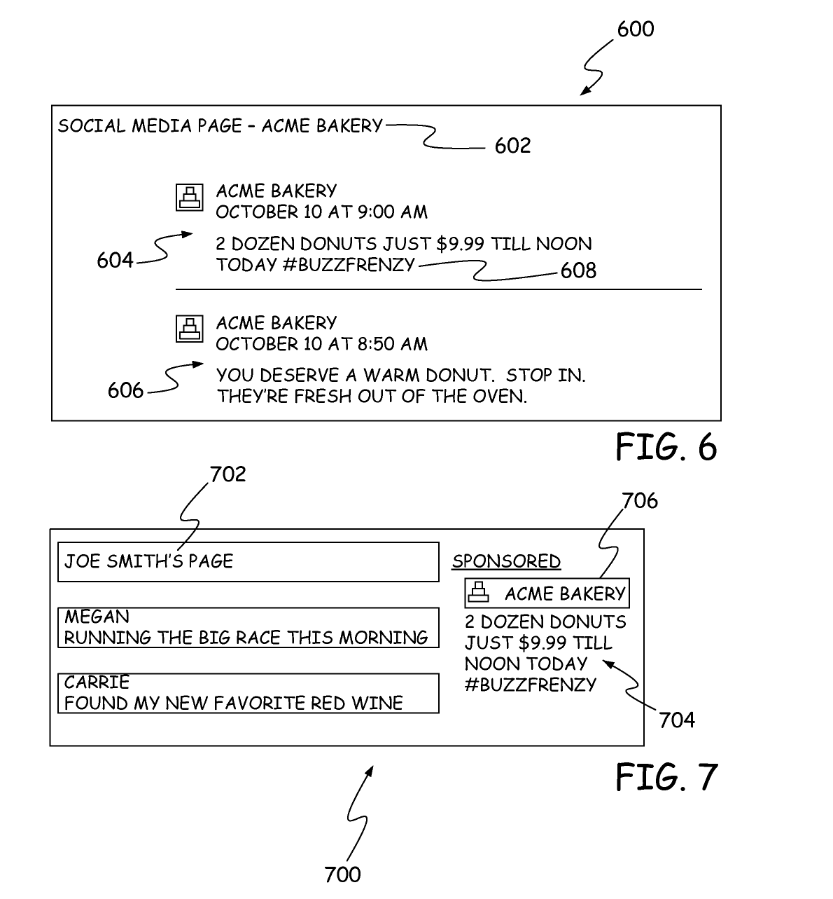

FIG. 6 provides an example of a posting site, such as media postings sites 156 and 158 of FIG. 1. In posting site 600 of FIG. 6, a business 602 has submitted two postings 604 and 606. Posting 606 does not include an action trigger but posting 604 does include an action trigger 608 of “#BUZZFRENZY”. As a result, when posting searcher 150 parses posting 606, it will not find an action trigger, and as such, will not activate action execution service 180 for that posting. On the other hand, when posting searcher 150 parses posting 604, it finds action trigger 608 and in response calls action execution service 180, which then creates an advertisement from posting 604.

FIG. 7 provides an example of user interface 700 showing a social media page generated by media servers 190/192 that contain an advertisement created by action execution service 180 based on posting 604 of FIG. 6. In particular, in FIG. 7, a social media page for a user 702 who has characteristics that meet the target psychographics 108 for the product/service ID 136 purchased by “ACME Bakery” has received an advertisement 704 that was created based on posting 604. In particular, advertisement 704 contains the text of posting 604. Advertisement 704 also includes the identity 706 of the business, which is taken from the identity set for the business on the business' social media page. Although only text is shown in advertisement 704, if posting 604 had also included other content such as video, images, hyperlinks, or audio, for example, the other content would also have been shown in advertisement 704.

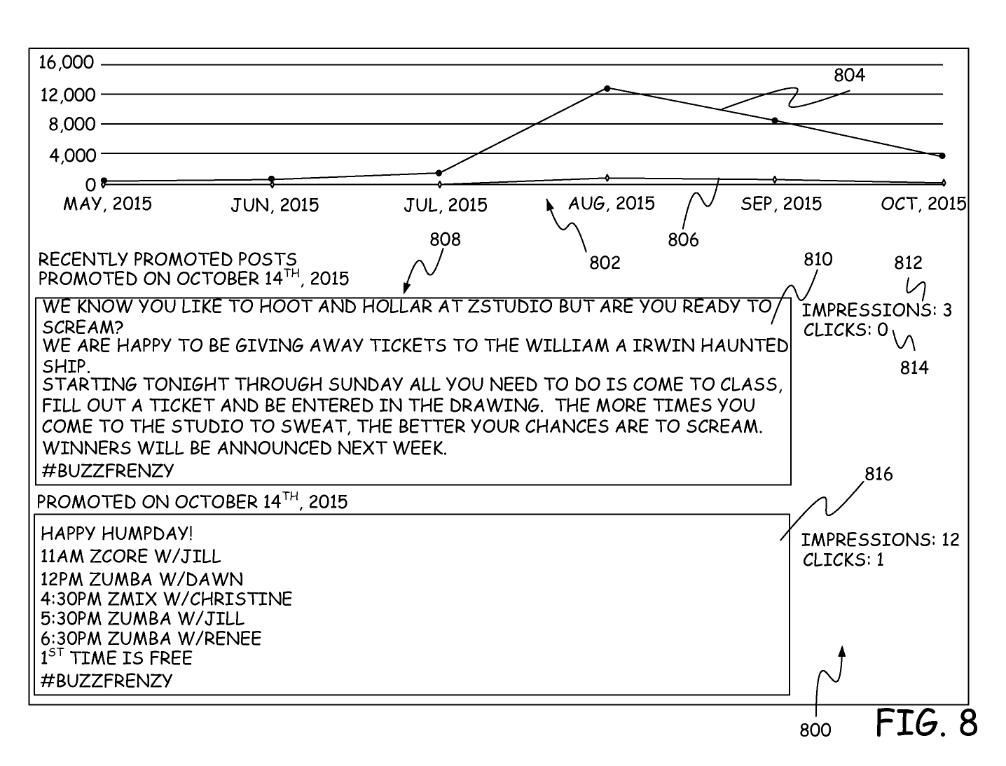

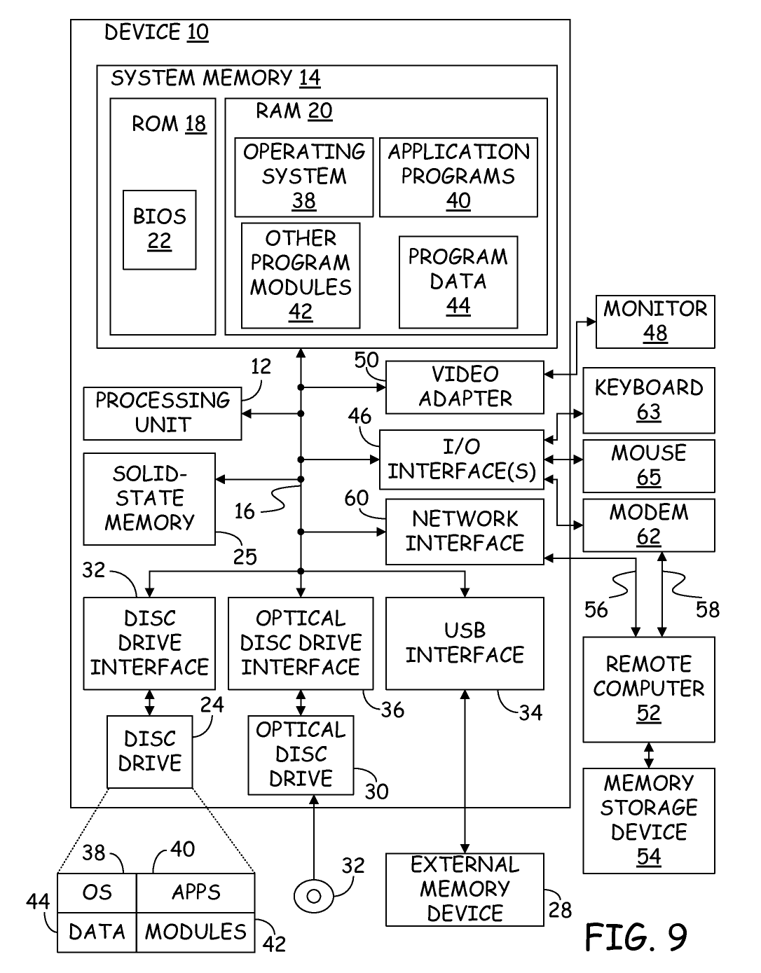

Media servers 190 and 192 keep track of the number of times the advertisement is presented to consumers, known as impressions, and the number of times that consumers click on the advertisement to bring the consumer to the business' media page. An engagement service 198 on advertising generation server 112 allows the account holder to use business client device 116/118 to request impressions and clicks for each advertisement that was promoted using an action trigger. FIG. 8 provides a user interface showing the engagement levels provided by engagement service 198. In particular, user interface 800 includes monthly summary 802, which includes a graph 804 for impressions for the month and a graph 806 for clicks for the month. In addition, user interface 800 includes recently promoted posts section 808, which includes the most recently promoted posts, such as promoted post 810 and promoted post 816. For each promoted post, the number of impressions, such as impression number 812, and the number of clicks, such as clicks 814, are also provided on user interface 800.

FIG. 9 provides an example of a computing device 10 that can be used as a server device or client device in the embodiments above. Computing device 10 includes a processing unit 12, a system memory 14 and a system bus 16 that couples the system memory 14 to the processing unit 12. System memory 14 includes read only memory (ROM) 18 and random access memory (RAM) 20. A basic input/output system 22 (BIOS), containing the basic routines that help to transfer information between elements within the computing device 10, is stored in ROM 18. Computer-executable instructions that are to be executed by processing unit 12 may be stored in random access memory 20 before being executed.

Embodiments of the present invention can be applied in the context of computer systems other than computing device 10. Other appropriate computer systems include handheld devices, multi-processor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present invention may be accomplished utilizing either local or remote storage devices, or simultaneously utilizing both local and remote storage devices.

Computing device 10 further includes a hard disc drive 24, an external memory device 28, and an optical disc drive 30. External memory device 28 can include an external disc drive or solid state memory that may be attached to computing device 10 through an interface such as Universal Serial Bus interface 34, which is connected to system bus 16. Optical disc drive 30 can illustratively be utilized for reading data from (or writing data to) optical media, such as a CD-ROM disc 32. Hard disc drive 24 and optical disc drive 30 are connected to the system bus 16 by a hard disc drive interface 32 and an optical disc drive interface 36, respectively. The drives and external memory devices and their associated computer-readable media provide nonvolatile storage media for the computing device 10 on which computer-executable instructions and computer-readable data structures may be stored. Other types of media that are readable by a computer may also be used in the exemplary operation environment.

A number of program modules may be stored in the drives and RAM 20, including an operating system 38, one or more application programs 40, other program modules 42 and program data 44. In particular, application programs 40 can include programs for implementing advertising generation server 112 including programs for implementing account registration service 114, posting searcher 150, action execution service 180 and engagement service 198. Program data 44 may include data such as product/service records 104, account records 130, and action records 160, for example.

Processing unit 12, also referred to as a processor, executes programs in system memory 14 and solid state memory 25 to perform the methods described above.

Input devices including a keyboard 63 and a mouse 65 are connected to system bus 16 through an Input/Output interface 46 that is coupled to system bus 16. Monitor 48 is connected to the system bus 16 through a video adapter 50 and provides graphical images to users. Other peripheral output devices (e.g., speakers or printers) could also be included but have not been illustrated. In accordance with some embodiments, monitor 48 comprises a touch screen that both displays input and provides locations on the screen where the user is contacting the screen.

The computing device 10 may operate in a network environment utilizing connections to one or more remote computers, such as a remote computer 52. The remote computer 52 may be a server, a router, a peer device, or other common network node. Remote computer 52 may include many or all of the features and elements described in relation to computing device 10, although only a memory storage device 54 has been illustrated in FIG. 9. The network connections depicted in FIG. 9 include a local area network (LAN) 56 and a wide area network (WAN) 58. Such network environments are commonplace in the art.

The computing device 10 is connected to the LAN 56 through a network interface 60. The computing device 10 is also connected to WAN 58 and includes a modem 62 for establishing communications over the WAN 58. The modem 62, which may be internal or external, is connected to the system bus 16 via the I/O interface 46. Order 206 is received through either network interface 60 or modem 62.

In a networked environment, program modules depicted relative to the computing device 10, or portions thereof, may be stored in the remote memory storage device 54. For example, application programs may be stored utilizing memory storage device 54. In addition, data associated with an application program may illustratively be stored within memory storage device 54. It will be appreciated that the network connections shown in FIG. 9 are exemplary and other means for establishing a communications link between the computers, such as a wireless interface communications link, may be used.

Although the present invention has been described with reference to preferred embodiments, workers skilled in the art will recognize that changes may be made in form and detail without departing from the spirit and scope of the invention.

What is claimed is:

1. A computer-implemented method comprising:
retrieving a media posting;
searching the media posting for a keyword;
when the keyword is present in the media posting:
retrieving an action associated with the keyword;
retrieving target psychographic information associated with the media posting; and
executing the action while utilizing the target psychographic information.

2. The computer-implemented method of claim 1 wherein executing the action comprises placing an advertisement with a network site such that the network site displays the advertisement to people who correspond with the target psychographic information.

3. The computer-implemented method of claim 1 further comprising retrieving area information associated with the media posting and wherein executing the action further comprises executing the action while utilizing the area information.

4. The computer-implemented method of claim 3 wherein executing the action comprises placing an advertisement with a network site such that the network site displays the advertisement to people who correspond with the area information and the target psychographic information.

5. The computer-implemented method of claim 1 wherein executing the action comprises placing an advertisement with a network site wherein the advertisement contains the media posting.

6. The computer-implemented method of claim 1 wherein executing the action comprises:
determining a remaining advertising budget;
determining an advertisement spending amount based on the remaining advertising budget; and
placing an advertisement with a network site using the advertisement spending amount.

7. The computer-implemented method of claim 1 wherein retrieving a media posting comprises retrieving a plurality of social media postings across a plurality of social media sites.

8. A server comprising:
a database associating a posting site on a network with a retail industry and a geographic area; and
a processor executing a posting searcher that searches the posting site for a keyword and an action executor that executes an action when the posting searcher finds the keyword, wherein the action is applied to the geographic area.

9. The server of claim 8 wherein the action comprises placing an advertisement that is distributed to people in the geographic area.

10. The server of claim 8 wherein the database further associates the retail industry with psychographic information and wherein the action is further applied to people that match the psychographic information.

11. The server of claim 8 wherein the action comprises placing an advertisement that is distributed to people that match the psychographic information and are in the geographic area.

12. The server of claim 11 wherein placing an advertisement comprises inserting text from the posting site in the advertisement.

13. The server of claim 8 wherein the database further associates an account with the retail industry, geographic area and the posting site.

14. The server of claim 13 wherein the database associates multiple posting sites with the combination of the account, retail industry and geographic area.

15. A method comprising:
searching a posting on a network site for a trigger;
when the trigger is found:
retrieving psychographic information associated with the posting; and
creating and activating an advertisement based on content in the posting and so that the advertisement is directed to people who match the psychographic information.

16. The method of claim 15 further comprising retrieving a geographic area associated with the posting and wherein creating and activating an advertisement comprises creating and activating an advertisement directed to people who live in the geographic area.

17. The method of claim 16 wherein the psychographic information is further associated with a retail industry.

18. The method of claim 15 wherein creating and activating an advertisement further comprises retrieving a remaining advertising budget and determining an advertisement spending amount for the advertisement based on the remaining advertising budget.

19. The method of claim 15 wherein creating the advertisement comprises using the content in the posting as the creative content of the advertisement.

20. The method of claim 15 wherein searching a posting on a network site comprises searching a plurality of postings on a plurality of network sites.
